(19) United States
(12) Patent Application Publication
(10) Pub. No.: US 2006/0260759 A1
(43) Pub. Date: Nov. 23, 2006

(54) Tape dispenser with cap

(76) Inventor: Harrison Huang, Taichung Hsien (TW)

Correspondence Address: BACON & THOMAS, PLLC, 625 SLATERS LANE, FOURTH FLOOR, ALEXANDRIA, VA, 22314, US

(21) Appl. No.: 11/326,315

(22) Filed: Jan. 6, 2006

(30) Foreign Application Priority Data
Apr. 27, 2005 (TW) 94206654

(51) Int. Cl. B44C 7/00; E04D 15/00

(52) U.S. Cl. 156/577

(57) ABSTRACT

A tape dispenser includes a case and a cap. The case consists of a first case member and a second case member with a protrusion at a center respectively. The case is to receive a tape roll therein and is provided with an opening and a cutter to draw the tape out and cut it off. The cap has two parallel side plates and a top plate between the side plates. The side plates have a hole respectively to be fitted to the protrusions of the case, such that the cap is rotated to shield the opening and the cutter by the top plate, and the cap also gives the first and second case members a strong coupling force.

### BACKGROUND OF THE INVENTION

1. Field of the Invention

The present invention relates generally to a tape dispenser, and more particularly to a tape dispenser, which is provided with a cap to protect user form hurt.

2. Description of the Related Art

Tape dispenser is the popular stationery in office, which is provided with a cutter to cut the tape off. To prevent user from hurt by the cutter, there are dispensers, which cutter is made of plastics or provides a cap the shield the cutter.

The conventional tape dispenser has two pieces coupled together. The pieces are provided with a rod and a hole respectively, which the rod is inserted into the hole to couple the pieces. There is a weak coupling condition between the pieces, so that the tape dispenser always is broken when it fell down to the ground and the pieces and tape are separated.

### SUMMARY OF THE INVENTION

The primary objective of the present invention is to provide a tape dispenser, which can prevent user from hurt by the cutter.

To achieve the objective of the present invention, a tape dispenser includes a case and a cap. The case has a cutter and an opening thereon to receive a tape roll therein. The cap is disposed on the case to be rotated between a first position, in which the cap shields the cutter, and a second position, in which the cap unshields the cutter.

The secondary objective of the present invention is to provide a tape dispenser, which has a strong coupling condition between the components thereof.

To achieve the objective of the present invention, a tape dispenser includes a case and a cap. The case has a first case member and a second case member detachably connected to each other. The cap has two side plates detachably coupling to the first case member and the second case member respectively.

### BRIEF DESCRIPTION OF THE DRAWINGS

FIG. 1 is a perspective view of a preferred embodiment of the present invention;

FIG. 2 is an exploded view of the preferred embodiment of the present invention;

FIG. 3 is a front view of the preferred embodiment of the present invention, showing the cap shielding the cutter; and

FIG. 4 is a front view of the preferred embodiment of the present invention, showing the cap unshielding the cutter.

### DETAILED DESCRIPTION OF THE INVENTION

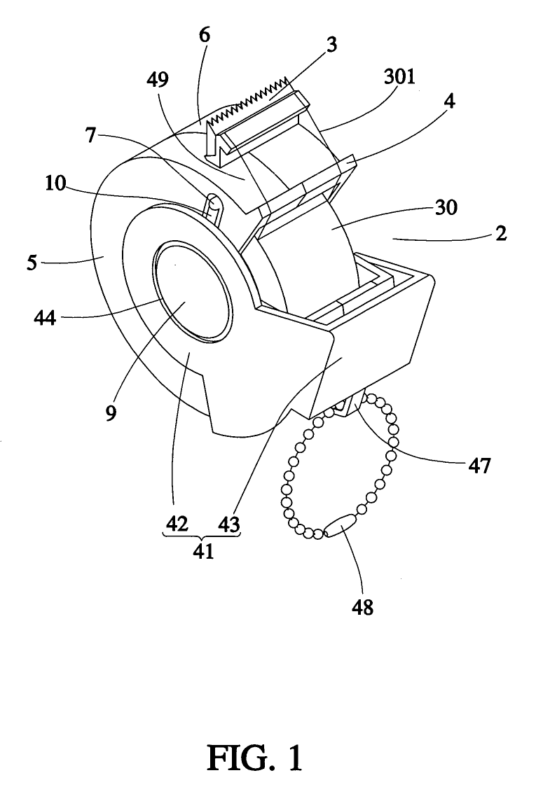

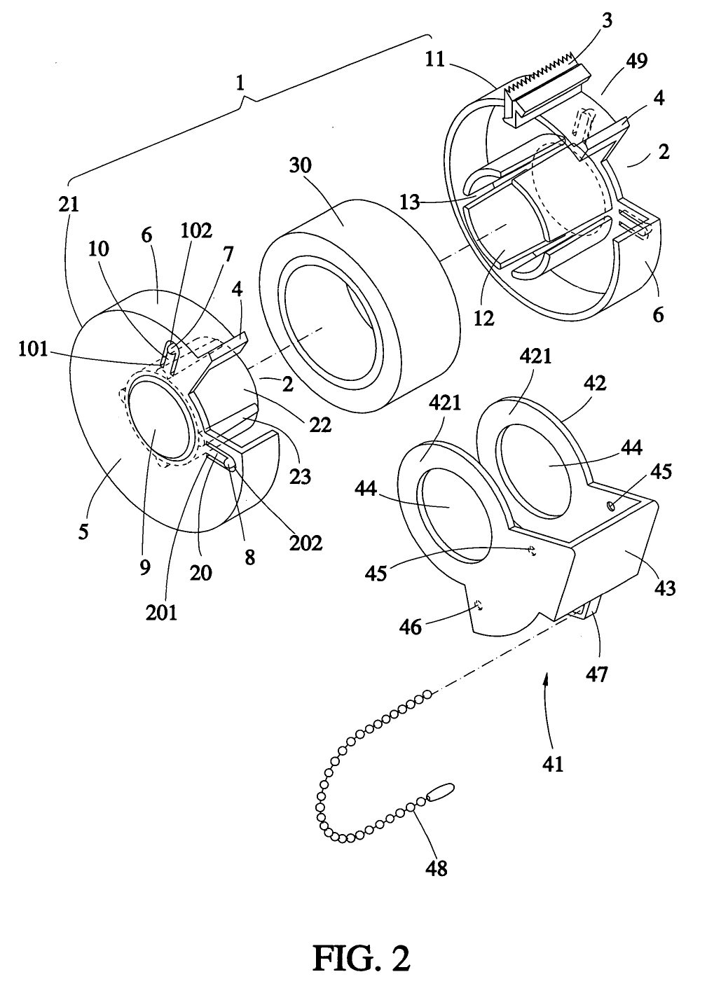

As shown in FIG. 1 to FIG. 2, a tape dispenser of the preferred embodiment of the present invention comprises:

A case 1, which is consisted of first case member 11 and a second case member 21, has a two end sides 5 and an annular side 6. The first and second case members 11 and 12 have a hollow first column 12 and a hollow second column 22 on interior sides thereof, which the second column 22 has an outer diameter less than an inner diameter of the first column 12 to be inserted into the first column 12. The second column 22 has four ribs 23 on a bottom of the circumference and the first column 11 has four gaps 13 to receive the ribs 23 respectively, when the second column 22 is inserted into the first column 12. When the second column 22 is inserted into the first column 12, they provide an axle to mount a tape roll 30.

The case 1 has an opening 2 on the annular side 6, a cutter 3 beside the opening 2 and a wall 4 between the opening 2 and the cutter 3. The tape 301 of the roll 30 can be pulled out of the case 1 via the opening 2 and cut off by the cutter 3. There is a space 49 between the wall 4 and the cutter 3 allowing user putting finger under the tape 301 to hold the tape 301. The case 1 further has a protrusion 9 on the center of each end side 5 and a first and a second suspended arm 10 and 20. The second suspended arm 20 is beside the cutter 3 and the first suspended arm 10 is beside the opening 2. Each of the suspended arms 10 and 20 has a base end 101, 102 and a suspended end 102, 202 respectively, and on the suspended end 102, 202, a first block 7 and a second block 8 are provided respectively.

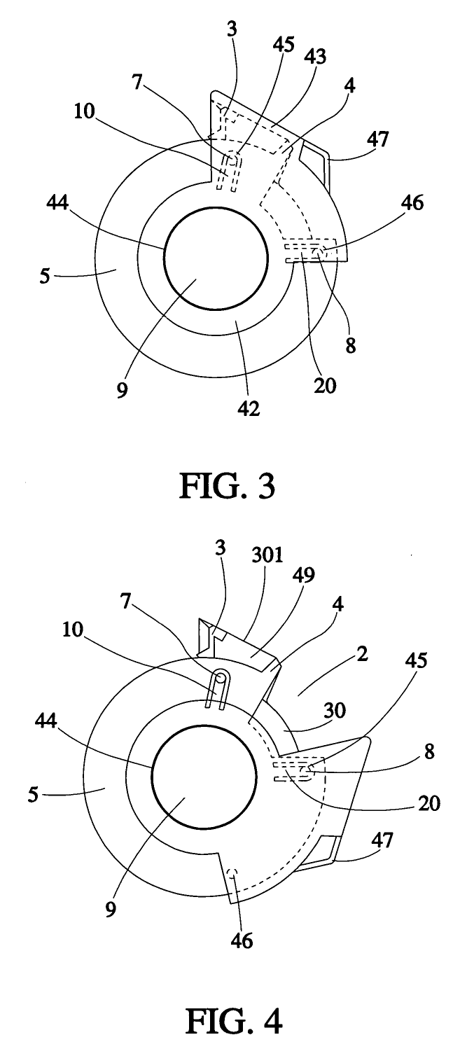

A cap 41 consists of two side plates 42 and a top plate 43. The side plates 42 are parallel to each other and the top plate 43 has opposite end connected to ends of the side plates 42 respectively. The side plates 42 have a free end 421 opposite to the top plate 43, a hole 44 adjacent to the free end 421 and two recesses 45, 46 on an interior side respectively. The top plate 43 has a hole 47 to be fastened with a chain 48. The cap 41 may be coupled to the case 1 with the holes 44 of the cap 41 fitted to the protrusions 9 on the end sides 5 of the case 1, in which the side plates 42 of the cap 41 will be against the end sides 5 to clip the first and second case members 11 and 21 and the top plate 43 is above the annular side 6. As a result, the cap 41 may rotate with the protrusions being the center of rotation. The cap 41 may rotate to a first position, referring to FIG. 3, in which the top plate 43 shields the opening 2 and the cutter 3, and the first and second blocks 7, 8 is received in the recess 46 on the side plates 42, and a second position, referring to FIG. 4, in which the top plate 43 unshields the opening 2 and the cutter 3, and the first and second blocks 7, 8 is received in the recess 45 on the side plates 42.

In use of the tape dispenser of the present invention, user may rotates the cap 41 to the second position (FIG. 4) to expose the opening 2 and the cutter 3 that allow user to draw the tape 301 out and cut it off by the cutter 3. When not in use, user may rotates the cap 41 to the second position (FIG. 3) to shield the opening 2 and the cutter 3 that can prevent dust entering the case via the opening 2 and prevent user being cut by the cutter 3.

The cap 41 further provides a coupling force to the case 1 to help the first and second case member 11 and 21 of the case 1 coupled together even when the tape dispenser fell down on the ground.

What is claimed is:

1. A tape dispenser, comprising:
a case with a cutter and an opening beside the cutter, in which a tape roll is received; and
a cap disposed on the case to be rotated between a first position, in which the cap shields the cutter, and a second position, in which the cap unshields the cutter.

2. The tape dispenser as defined in claim 1, wherein the case is provided with a block and the cap is provided with a recess to receive the block when the cap is rotated to the first position.

3. The tape dispenser as defined in claim 2, wherein the case has a suspended arm, on which the block is provided.

4. The tape dispenser as defined in claim 1, wherein the case is provided with a block and the cap is provided with a recess to receive the block when the cap is rotated to the second position.

5. The tape dispenser as defined in claim 4, wherein the case has a suspended arm, on which the block is provided.

6. The tape dispenser as defined in claim 1, wherein the case has a protrusion and the cap has a hole fitted to the protrusion, such that the cap rotates with the protrusion being a center of rotation.

7. The tape dispenser as defined in claim 1, wherein the cap has two side plates, on each of which a hole is provided and a top plate between the side plates, and the case has two protrusions on opposite side to be received in the holes of the cap.

8. The tape dispenser as defined in claim 1, wherein the cap further shields the opening when the cap is rotated to the first position.

9. The tape dispenser as defined in claim 1, wherein the case further has a wall between the opening and the cutter.

10. A tape dispenser, comprising:
a case having a first case member and a second case member detachably connected to each other, on which a cutter is provided; and
a cap having two side plates detachably coupling to the first case member and the second case member respectively.

11. The tape dispenser as defined in claim 10, wherein the first case member and the second case member are provided with a protrusion respectively and the side plates of the cap are provided with a hole to be fitted to the protrusions respectively.

12. The tape dispenser as defined in claim 10, wherein the cap further has a top plate with opposite ends connected to the side plates respectively.
